(19) United States
(12) Patent Application Publication
(10) Pub. No.: US 2013/0262446 A1
(43) Pub. Date: Oct. 3, 2013

(54) SEARCH APPARATUS AND COMPUTER READABLE MEDIUM

(71) Applicants: Keisuke MINAMI, Kanagawa-ken (JP); Daisuke AJITOMI, Kanagawa-ken (JP); Kotaro ISE, Kanagawa-ken (JP)

(72) Inventors: Keisuke MINAMI, Kanagawa-ken (JP); Daisuke AJITOMI, Kanagawa-ken (JP); Kotaro ISE, Kanagawa-ken (JP)

(73) Assignee: KABUSHIKI KAISHA TOSHIBA, Tokyo (JP)

(21) Appl. No.: 13/613,400

(22) Filed: Sep. 13, 2012

(30) Foreign Application Priority Data
Mar. 29, 2012 (JP) 2012-078366

(51) Int. Cl. G06F 17/30

(52) U.S. Cl. CPC G06F 17/30424
USPC 707/722

(57) ABSTRACT

A terminal configured to be communicable with a server capable of separating a total set of a search index into a plurality of subsets and providing the plurality of subsets includes: a specifying unit configured to specify a specific subset from the plurality of subsets; an acquisition unit configured to acquire the subset specified by the specifying unit from the server; a holding unit configured to hold the subset acquired by the acquisition unit; and a search processing unit configured to perform search processing by using a search index of the subset held by the holding unit.

### CROSS-REFERENCE TO RELATED APPLICATIONS

This application is based upon and claims the benefit of priority from the prior Japanese Patent Application No. 2012-078366, filed on Mar. 29, 2012, the entire contents of which are incorporated herein by reference.

### FIELD

Embodiments relate to a search apparatus and a computer readable medium.

### BACKGROUND

To execute search processing at high speed, a search system in which a search index is created in advance is widely used. The search index has a data structure in which, for example, a partial character string such as a word or a clause is associated with some content IDs (identifier). The content ID is used for specifying content in which the partial character string appears. Here, the partial character string to be stored in the search index is referred to as a key (or direction word) of the search index.

For example, in the case where the partial character string is represented in English, an initial character of the key of the search index may be present in the range of “A” to “Z”.

In the search system using the search index, upon reception of a search request including a search keyword from a user, search processing is executed. The search processing is processing of searching the search index for a key that matches the search keyword and returning, to the user, content IDs associated with the key as a search result.

In the past, a search index in a web content search service or the like has been placed on a service provider side such as a web server, not in a terminal on the user side (hereinafter, referred to as user terminal). For that reason, when a user inputs a search keyword into the user terminal (for example, PC (personal computer)), the service provider has performed search processing using the search index. After that, the service provider has returned a search result to the user terminal.

Meanwhile, a system in which a search index is acquired in advance from the service provider to the user terminal and then search processing is performed in an apparatus on the user side has been developed in recent years.

In the case where the search index is located in the server, it is necessary for the user terminal to access the server before performing search processing. Therefore, it takes long time for the user to obtain a search result after the input of a search keyword, compared with the case where the search processing is achieved with only the user terminal. More specifically, it takes extra time to communicate between the user terminal and the server.

On the other hand, in a system in which the user terminal acquires a search index in advance, the following problems remain. In recent years, an information amount has been abruptly increased due to an abrupt increase of the amount of content and the like. Therefore, the entire size of the search index held by the server may be significantly increased. In such a case, the entire size of the search index held by the server may exceed the acquisition performance (communication speed, storage capacity, etc.) of a search apparatus. As a result, it is assumed that the user terminal acquires only a part of the search index of the server. In the case where the user terminal acquires a part of the search index of the server at random, it is assumed that the search processing is not enabled to be performed from the beginning or that an appropriate search result is not obtained even if the search processing is enabled to be performed.

For example, in the case where the user terminal acquires a search index of the server at random, the server assumes a case that the search index held by the server is transmitted to the user terminal in the alphabetical order of initial characters of keys of the search index. In this case, if the user terminal is allowed to acquire only a part of the search index stored by the server, a search index having an initial character of a key in the range of “A” to “F” is obtained. However, a search index having an initial character in the range of “G” to “Z” may not be obtained. In such a case, if the user inputs a word having an initial character of “G” as a search keyword, it is assumed that the user terminal is not allowed to obtain a search result.

The above-mentioned technology is disclosed in Japanese Patent Application Laid-Open No. 2008-109480, and contents of which are hereby incorporated by reference.

### BRIEF DESCRIPTION OF THE DRAWINGS

FIG. 1 is a diagram showing a communication system including a search apparatus according to a first embodiment;

FIG. 2 is a diagram showing an example of subsets of a search index held by a server;

FIG. 3 is a diagram showing an example of a subset of the search index held by the search apparatus;

FIG. 4 is a flowchart showing acquisition processing for a subset of the search index;

FIG. 5 is a flowchart showing search processing by the search apparatus;

FIG. 6 is a diagram showing content information held by a content holding unit;

FIG. 7 is a block diagram showing a server as a modified example of the server shown in FIG. 1;

FIG. 8 is a diagram showing a communication system including a search apparatus according to a second embodiment;

FIG. 9 is a diagram showing data held by a content holding unit of a server shown in FIG. 8;

FIG. 10 is a diagram showing data held by a content holding unit of the search apparatus;

FIG. 11 is a flowchart showing acquisition processing by the search apparatus;

FIG. 12 is a flowchart showing search processing by the search apparatus;

FIG. 13 is a diagram showing a communication system according to a third embodiment;

FIG. 14 is a diagram showing a communication system according to a fourth embodiment;

FIG. 15A is a diagram showing a server according to the fourth embodiment, and FIG. 15B is a diagram showing data stored by a correction dictionary holding unit of the server;

FIG. 16 is a diagram showing data stored by a correction dictionary holding unit of a search apparatus; and

FIG. 17 is a diagram showing a communication system according to a fifth embodiment.

### DETAILED DESCRIPTION

A search apparatus according to an embodiment is a search apparatus configured to be communicable with a server capable of separating a total set of a search index into a plurality of subsets and providing the plurality of subsets, the search apparatus including: a specifying unit configured to specify a specific subset from the plurality of subsets; an acquisition unit configured to acquire the subset specified by the specifying unit from the server; a holding unit configured to hold the subset acquired by the acquisition unit; and a search processing unit configured to perform search processing by using a search index of the subset held by the holding unit.

According to an embodiment, even in the case where a user terminal acquires a partial search index in the entire search index held by the server, the user terminal obtains an appropriate search result by using the partial search index.

Hereinafter, embodiments will be described with reference to the drawings. Note that the same components in the respective drawings are denoted by the same reference symbols and overlapping descriptions thereof will be omitted.

### First Embodiment

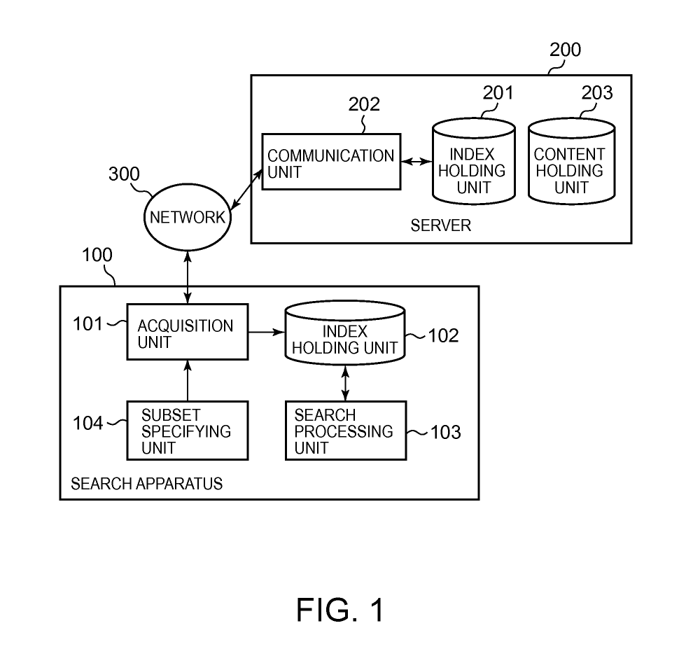

FIG. 1 is a block diagram showing a communication system according to a first embodiment.

The communication system according to the first embodiment includes a search apparatus 100, a server 200, and a network 300. The search apparatus 100 as a user terminal is communicable with the server 200 serving as a service provider via the network 300.

The search apparatus 100 is, for example, a PC (personal computer) or a mobile phone. As will be described later, the search apparatus 100 acquires a subset of a search index from the server 200 and performs search processing by using the subset of the search index.

The server 200 is, for example, a web server or a file server. The server 200 is an apparatus capable of separating a total set of the search index held by the server 200 into subsets and providing them. For example, the server 200 includes an index holding unit 201 that holds a plurality of subsets, which are obtained by classifying the total set of the search index from predetermined viewpoints. The server 200 provides a subset of the search index to the search apparatus 100 via a communication unit 202 in response to a request from the search apparatus 100. For example, when the communication unit 202 of the server 200 receives from the search apparatus 100 a request to acquire a specific subset, the communication unit 202 acquires the requested subset from the index holding unit 201 and then returns the subset to the search apparatus 100. Note that the server 200 may include a content holding unit 203 that holds content to be provided to the search apparatus 100. The network 300 is, for example, the Internet or a LAN (local area network).

The search apparatus 100 includes an acquisition unit 101, an index holding unit 102, a search processing unit 103, and a subset specifying unit 104.

The acquisition unit 101 acquires a subset of the search index from the server 200 via the network 300. For example, the acquisition unit 101 transmits an acquisition request for a subset to the server 200 and acquires the subset as a response to the request. The search index includes search index items each containing, for example, a character string (referred to as key) and a search result corresponding thereto. Here, the search result is, for example, a set of content IDs (identifier) for specifying content including the character string of the key. Here, the content ID is, for example, a URI (uniform resource identifier) as a storage destination of content.

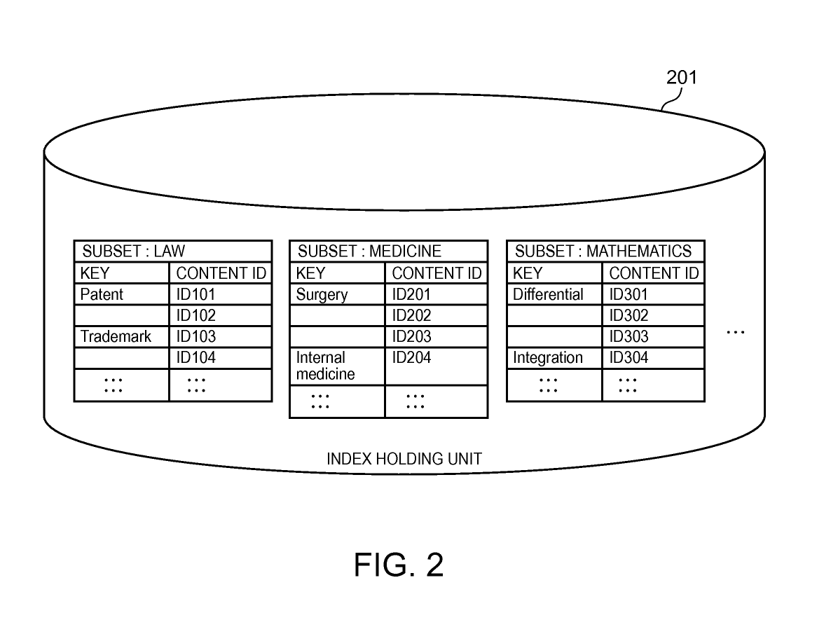

FIG. 2 shows an example of subsets of the search index held by the index holding unit 201 of the server 200. Examples of the subsets of the search index include “Law”, “Medicine”, and “Mathematics”. For example, a subset of the search index that is related to “Law” is a set obtained by a collection of search index items each corresponding to a word containing a key related to law. As an example of the subset, a set that includes all search index items each corresponding to a word containing a key related to law in the total set of the search index held by the server 200 will be described below. However, the subset only needs to be such a set that an appropriate search result is returned for the search processing, out of the search index items each corresponding to a word containing a key related to law, and the subset does not necessarily include all the search index items corresponding to words containing keys related to law. In other words, the subset only needs to be one of sets into which the server 200 classifies the total set of the search index from predetermined viewpoints, and to be such a set that an appropriate search result is returned for the search processing. Note that the subset related to “Law” has been described as an example, and the subset is not limited thereto.

In this manner, the acquisition unit 101 acquires a subset of the search index from the server 200. Therefore, even if the acquisition performance of the search apparatus 100 falls below the acquisition performance with which the total set of the search index held by the server 200 may be acquired, the search apparatus 100 acquires a subset in units of subsets of the search index. As a result, the search apparatus 100 performs search processing using a subset of the search index and performs appropriate processing as long as it is the search processing related to the classification of the subsets. Now, an example of the appropriate processing will be described. For example, in the case where a subset of the search index that is related to “Law” is acquired, all search index items including “A” to “Z” in initial characters of keys are acquired as the search index related to the “Law”. Therefore, a search result is obtained for any search keyword including any of “A” to “Z” in an initial character thereof. In this manner, processing without any omission is performed.

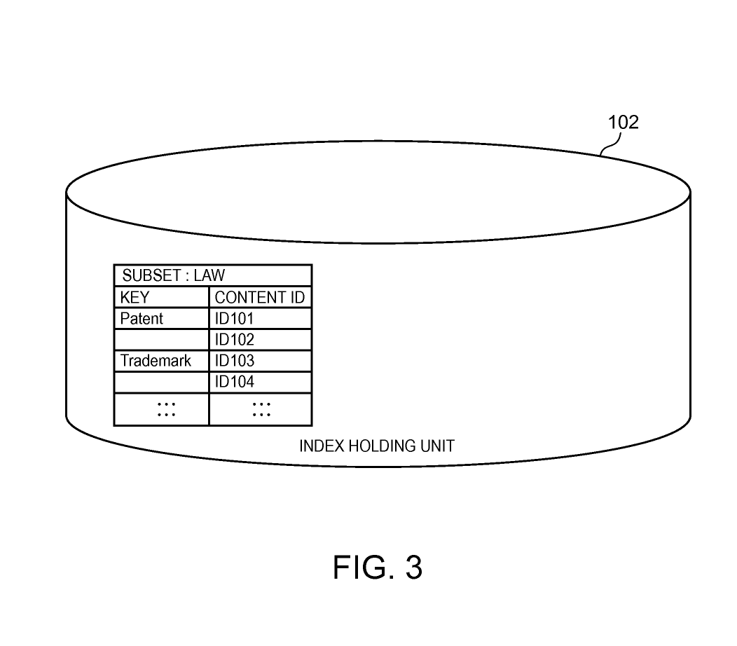

The index holding unit 102 holds the subset of the search index acquired by the acquisition unit 101 from the server 200. FIG. 3 shows an example in which the index holding unit 102 holds the subset of the search index related to the “Law” as a subset of the search index.

The index holding unit 102 may hold not only the subset of the search index but also subset metadata of the search index. The subset metadata is, for example, human-readable name information of a subset. For example, in the case where the subset is a set related to “Law”, metadata of the subset is “Law”. The subset metadata may be more detailed explanatory information on the subset. The subset metadata may further include date-and-time information such as a creation date and an expiration date of the subset metadata or may include the number of keys included in a subset of the search index.

The search processing unit 103 performs search processing by using the subset of the search index held by the index holding unit 102. For example, when the user inputs a search keyword, the search processing unit 103 searches for a word that matches the search keyword from keys of search index items included in the subset of the search index held by the index holding unit 102 and then acquires content IDs corresponding to the matching key. In this embodiment, the search processing refers to processing of acquiring content IDs by using a search index.

The subset specifying unit 104 specifies a subset of a search index to be acquired from the server 200 with respect to the acquisition unit 101.

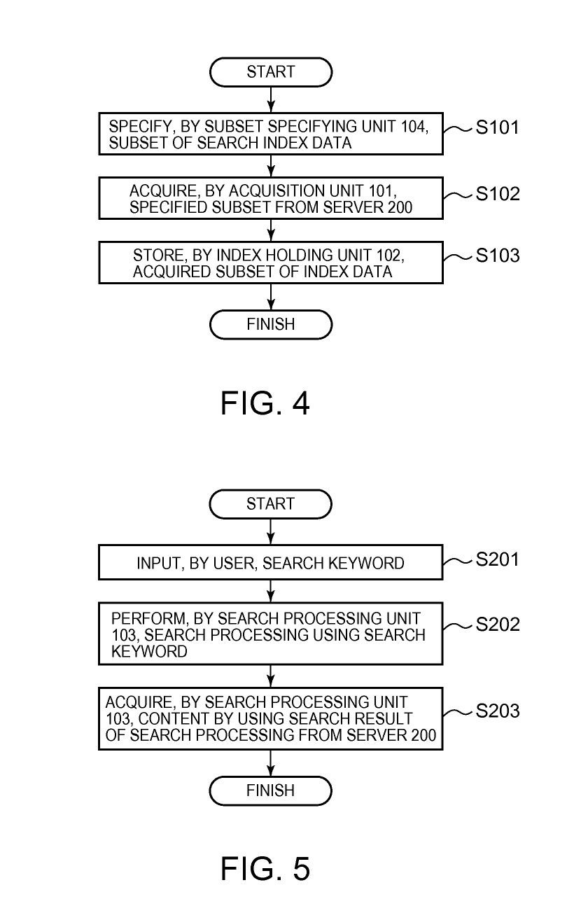

FIG. 4 is a flowchart showing acquisition processing for a subset of the search index by the search apparatus 100. With reference to FIGS. 1 and 4, the acquisition processing for a subset of the search index by the search apparatus 100 will be described.

First, using a numerical value or a character string, the subset specifying unit 104 specifies a subset of a search index to be used by the search apparatus 100 with respect to the acquisition unit 101 (S101). Here, a numerical value or a character string to be used for specifying a subset is, for example, name information of a subset. For example, a character string to be used for specifying a subset is “Law”. A numerical value or a character string to be used for specifying a subset may be information input by the user or information embedded into the search apparatus 100 in advance.

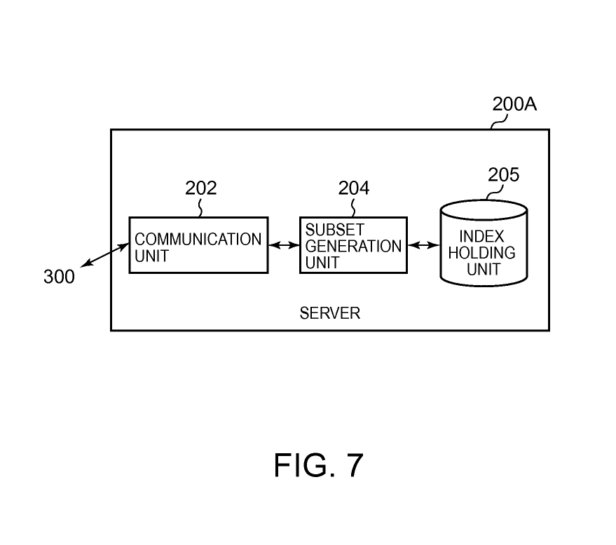

Note that the information to be used for specifying a subset is not limited to the numerical value or character string described above. The information to be used for specifying a subset may be, for example, status information of the search apparatus 100 (free space of storage area and processing ability) or information obtained by a sensor or the like attached to the search apparatus (position information etc.). Information on the search apparatus 100, such as the status information and the position information of the search apparatus 100, refers to apparatus information. Further, the information to be used for specifying a subset may be user information on the user (action history and preference information), which is accumulated in the search apparatus 100. For example, the subset specifying unit 104 specifies a subset with a data amount that may be acquired in accordance with a free space of a storage area or processing ability thereof. Further, the subset specifying unit 104 specifies, based on the position information, a subset related to an area near a corresponding position. For example, it is also assumed that the server 200 holds subsets classified for each of areas. Furthermore, as in the case of a server 200A that will be described later (see FIG. 7), in the case where the server 200A generates a subset in response to an acquisition request of the acquisition unit 101 and information to be used for specifying a subset is position information, the server 200A provides a subset related to a range within a predetermined distance based on the corresponding position. In such a case, processing using the position information is effective.

Additionally, in the case where the server 200 holds subsets that may be acquired as metadata of the total set of the search index, the subset specifying unit 104 may also specify a subset selected by the search apparatus 100 or the user from subsets indicated by the metadata acquired by the server 200.

Next, the acquisition unit 101 acquires the subset of the search index, which is specified by the subset specifying unit 104, from the server 200 (S102). For example, in the case where “Law” is specified as a subset to be acquired by the subset specifying unit 104, the acquisition unit 101 acquires a subset of the search index related to “Law” from the index holding unit 201 of the server 200 shown in FIG. 2.

Next, the index holding unit 102 stores the subset of the search index acquired by the acquisition unit 101 (S103). As shown in FIG. 3, the subset of the search index related to “Law” is stored in the index holding unit 102.

After that, the search processing unit 103 is allowed to use the subset held by the index holding unit 102 to perform search processing.

Next, an operation in which the search processing unit 103 uses the subset held by the index holding unit 102 to perform search processing will be described. FIG. 5 is a flowchart showing an operation of the search processing by the search apparatus 100. In the following description, the case where the index holding unit 102 holds the subset of “Law”, as shown in FIG. 3, will be described as an example.

First, the user inputs a search keyword in the search apparatus 100 (S201). For example, it is assumed that the user inputs a keyword of “Patent”. Note that the input of a search keyword is not limited to the input by the user. The search keyword may be automatically input based on a predetermined program.

Next, the search processing unit 103 searches for a search index item including a key that matches the search keyword from the subset of the search index held by the index holding unit 102 and acquires content IDs of the search index item as a search result (S202). In the example of FIG. 3, the content ID associated with “Patent” includes an ID 101 and an ID 102. Therefore, the search results are the ID 101 and the ID 102.

Note that the search processing unit 103 also acquires content corresponding to the search keyword after the search processing, using the ID 101 and the ID 102 as search results. Processing of acquiring content will also be described hereinafter.

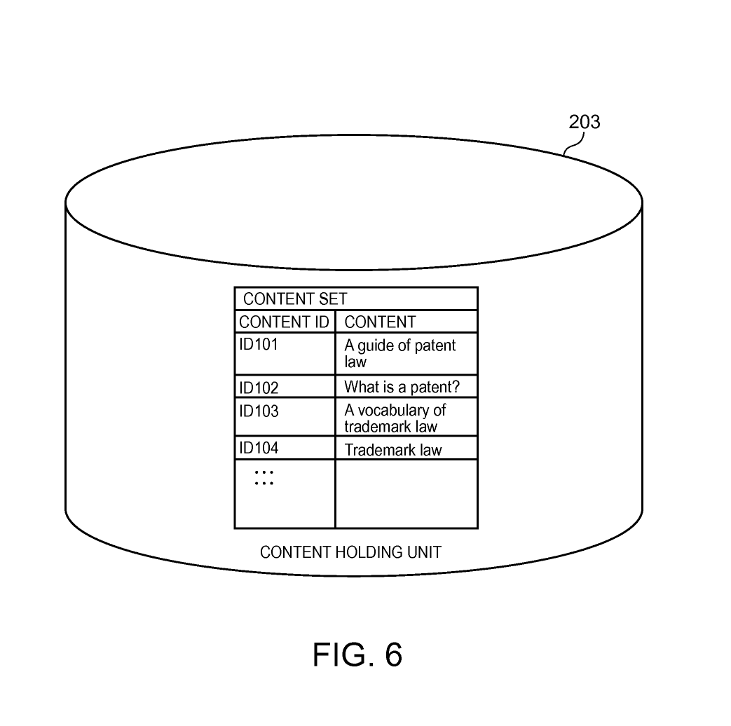

The search processing unit 103 accesses the content holding unit 203 of the server 200 via the network 300 and acquires content by using the search result (S203). Note that in the server 200, for example, the communication unit 202 detects whether the request from the search apparatus 100 is an acquisition request for a subset corresponding to the search keyword or an acquisition request for content information. FIG. 6 is a diagram showing content information held by the content holding unit 203. The content information is information including a content ID and content associated with each other. In the case where the search results are the ID 101 and the ID 102, the search processing unit 103 is allowed to acquire content items of “A guide of patent law” and “What is a patent?” as the content.

Upon acquisition of content, the search processing unit 103 may present the content to the user with use of a display unit (not shown).

According to this embodiment, the search apparatus 100 as a user terminal acquires any one of a plurality of subsets classified from a total set of the search index held by the server 200 and performs search processing by using index data of the subset, to thereby acquire an appropriate search result.

Note that the subset has been described in units of “Law”, “Medicine”, and “Mathematics” in the above example, but the subset is not limited thereto. The subset may be, for example, a set of products that applies to a specific category in a total set of products or a set of shops located at a specific area in all shops.

Further, the example in which the server 200 includes the index holding unit 201 and the index holding unit 201 holds the search index that is separated in advance for each subset has been described in this embodiment. However, the search index is not necessarily separated into subsets to be held. FIG. 7 shows the server 200A as a modified example of the server 200. The server 200A includes an index holding unit 205 and a subset generation unit 204. The index holding unit 205 holds index data without classifying it into subsets. Upon reception of an acquisition request for a subset from the acquisition unit 101 of the search apparatus 100, the subset generation unit 204 generates a subset of the index data from the index data of the index holding unit 205 and provides the subset. Thus, the server 200 only needs to be in a state to be able to provide a subset of index data.

Additionally, the example in which the search index has the following data structure has been described in this embodiment. In the data structure, a partial character string such as a word or a clause is associated with content IDs for specifying content in which the partial character string appears. However, the search index is not limited thereto. For example, the search index may have a data structure in which a numerical value is associated with content IDs for specifying content related to the numerical value. Alternatively, the search index may have a data structure in which a predetermined range of numerical values is associated with content IDs for specifying content related to a numerical value in the predetermined range of numerical values. Further, the search index may have a data structure in which coordinates are associated with content IDs for specifying content related to the coordinates. Furthermore, the search index may have a data structure in which a predetermined range of coordinates is associated with content IDs for specifying content related to coordinates in the predetermined range of coordinates. In addition, the search index may have a data structure in which a node is associated with content IDs for specifying content corresponding to a node that is in a connection relationship with the former node in graph structured data.

Further, the example in which the search apparatus 100 has only one acquisition source of content, which is the server 200, has been described in this embodiment. However, the search apparatus 100 may acquire content from different servers in accordance with content IDs.

Note that the search apparatus 100 is also achieved by using, for example, a general-purpose computer apparatus as basic hardware. In other words, the acquisition unit 101, the index holding unit 102, the search processing unit 103, and the subset specifying unit 104 are achieved by a processor, mounted in the above computer apparatus, executing a program. At this time, the search apparatus 100 may be achieved by installation of the above-mentioned program into the computer apparatus in advance or may be achieved by storing the program on a storage medium such as a CD-ROM (compact disk-read only memory) or distributing the program via a network and then installing the program into the computer apparatus as appropriate. Further, the index holding unit 102 is achieved by appropriate use of a hard disk, a memory incorporated or externally mounted into the computer apparatus described above, or storage media such as a CD-R (compact disk-recordable), a CD-RW (compact disk-rewritable), a DVD-RAM (digital versatile disk-random access memory), and a DVD-R (digital versatile disk recordable).

### Second Embodiment

A search apparatus 2100 according to a second embodiment is different from the search apparatus 100 according to the first embodiment in that the search apparatus 2100 also acquires a subset of content.

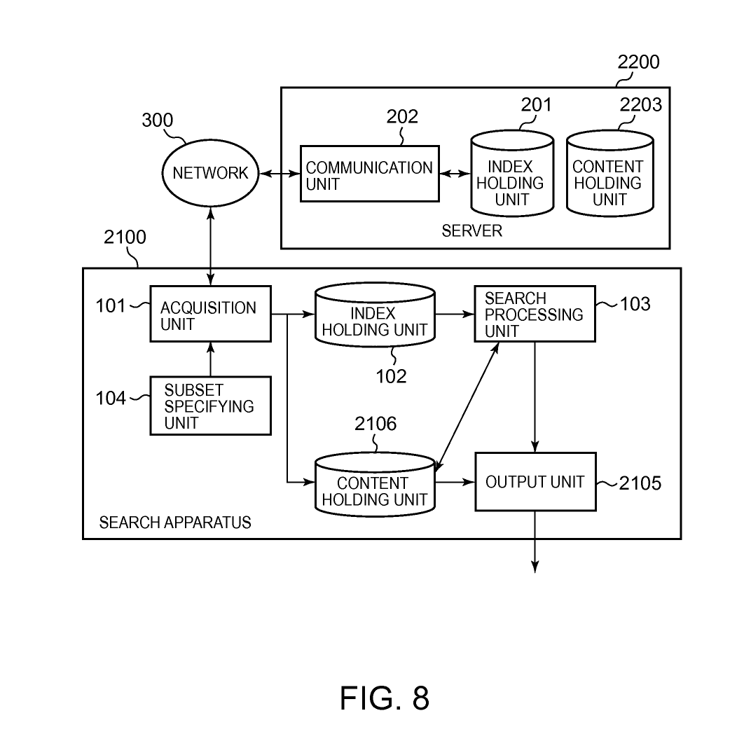

FIG. 8 is a block diagram showing a communication system according to the second embodiment.

As shown in FIG. 8, the search apparatus 2100 according to the second embodiment is different from the search apparatus 100 according to the first embodiment in that the search apparatus 2100 further includes an output unit 2105 and a content holding unit 2106.

The output unit 2105 is a display apparatus or the like and presents content to the user. Note that the output unit 2105 is not necessarily a display apparatus itself and may be, for example, a processing unit that outputs content to the display apparatus.

Further, an acquisition unit 101 according to the second embodiment acquires a subset of content information from a server 2200, in addition to performing the function of the acquisition unit 101 according to the first embodiment.

The content holding unit 2106 holds a subset of content information that corresponds to a subset of a search index held by an index holding unit 102. Here, the content information refers to, for example, information constituted of a combination of a content ID and content such as a web page. The content information may further include expiration date information of the content information or providing source information of the content information.

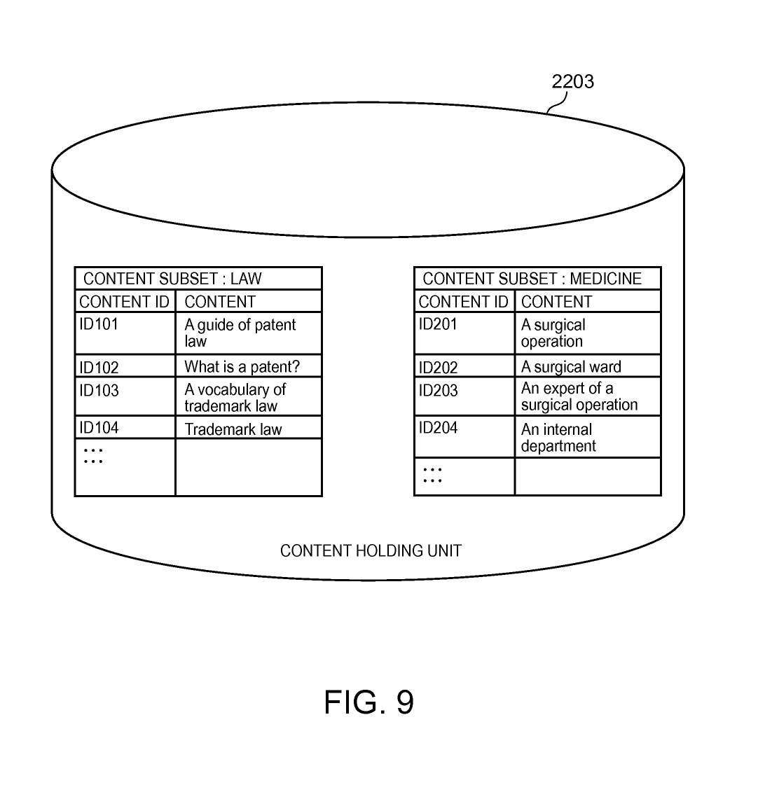

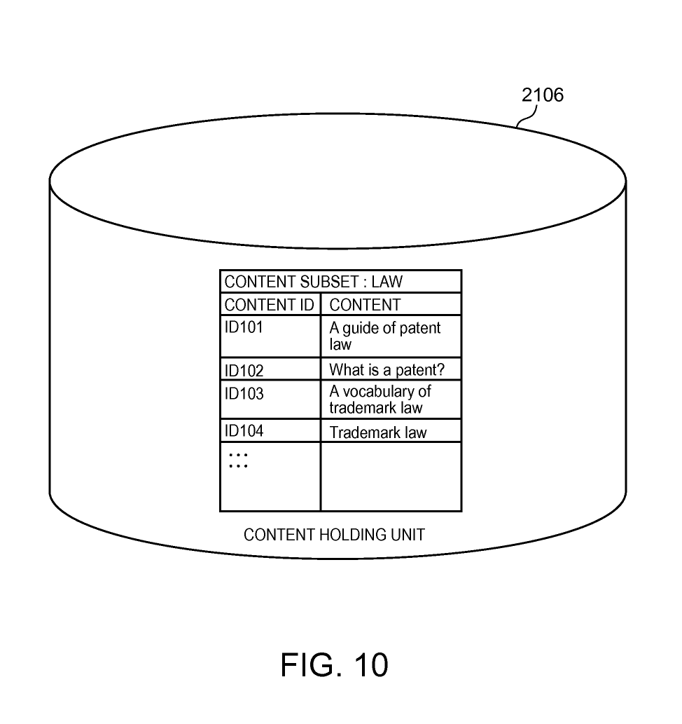

A subset of content information will be described with reference to FIGS. 9 and 10. FIG. 9 is a diagram showing an example of information stored by a content holding unit 2203 of the server 2200. FIG. 10 is a diagram showing an example of a subset of content that is acquired from the server 2200 by the acquisition unit 101 and held by the content holding unit 2106 of the search apparatus 2100.

As shown in FIG. 9, the server 2200 holds subsets of content information in units of “Law” and “Medicine”. FIG. 10 is a diagram showing an example in which the search apparatus 2100 acquires a subset of content information of “Law” from the server 2200.

Hereinafter, an operation of the search apparatus 2100 will be described.

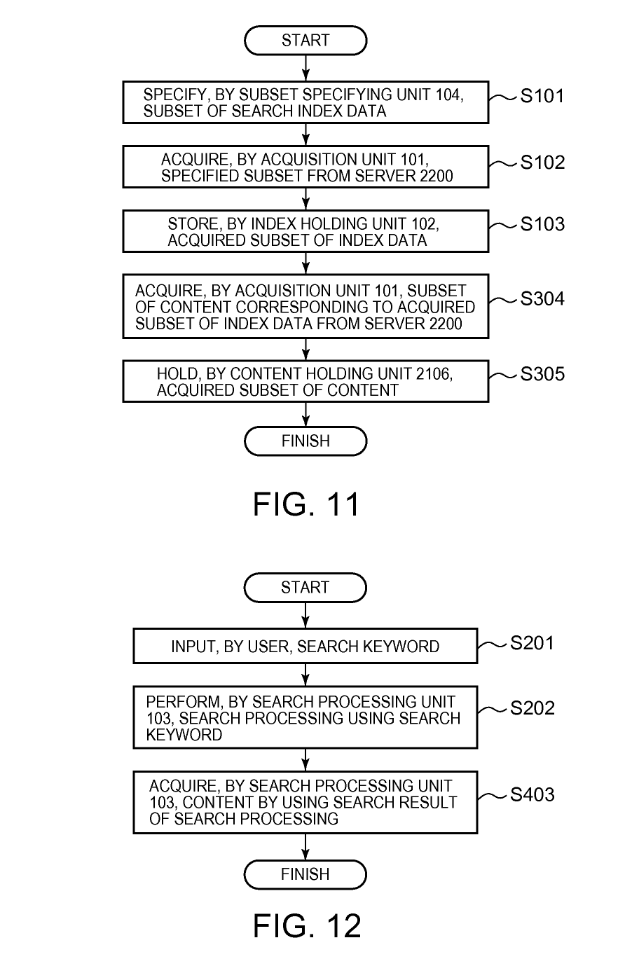

FIG. 11 is a flowchart showing processing, by the search apparatus 2100, of acquiring a subset of content data, the subset corresponding to a subset of a search index.

The search apparatus 2100 acquires a subset of the search index in Steps S101 to S103. For example, it is assumed that the search apparatus 2100 acquires a subset related to “Law”. The acquisition method is the same as in the first embodiment and therefore its description will be omitted.

Next, the acquisition unit 101 acquires a subset of content information that corresponds to the subset of the search index (S304). The acquisition unit 101 acquires a subset of content information related to “Law”. Next, the content holding unit 2106 holds the acquired subset of the content information (S305).

Next, search processing and content acquisition processing by the search apparatus 2100 using the acquired content information will be described.

FIG. 12 is a flowchart showing search processing and content acquisition processing by the search apparatus 2100.

The search apparatus 2100 performs search processing and acquires content IDs as a search result in Steps S201 and S202. For example, it is assumed that a search keyword is set to “Patent”, and IDs 101 and 102 are acquired as search results (see FIG. 3). The method for the search processing is the same as in the first embodiment, and therefore its description will be omitted.

Next, the search apparatus 2100 uses the search result of the search processing and the content information of the content holding unit 2106 to acquire content (S403). Specifically, the search apparatus 2100 acquires “A guide of patent law” as content corresponding to the ID 101 and “What is a patent?” as content corresponding to the ID 102 (see FIG. 10).

Next, the output unit 2105 presents the acquired two content items to the user. The presentation form includes, for example, displaying the outlines of the two content items at the same time. All the details of a specified content item may be displayed according to an instruction of the user or the like.

Since the search apparatus 2100 holds not only the search index but also content, a series of processing including the search processing and the content presentation is performed in the search apparatus 2100. As a result, a processing speed from the input of a search keyword to the presentation of content is improved. In addition, connection to the network is omitted in the processing from the input of the search keyword to the presentation of the content. Further, since the content information is acquired on the basis of a subset, even when a data amount of a total set of content held by the server 2200 exceeds the acquisition performance of the search apparatus 2100, the content presentation processing by the search apparatus 2100 is appropriately performed.

Note that the example in which the server 2200 holds all subsets of content information corresponding to the subsets of the search index has been described in this embodiment. However, the subset of content information may be separately held by a plurality of servers for each piece of content information. In such a case, when acquiring a subset of content information that corresponds to a subset of the search index, the search apparatus 2100 may acquire content information from each of the plurality of servers by, for example, using content IDs in the search index, and acquire the subset of content information.

### Third Embodiment

A search apparatus 3100 according to a third embodiment displays metadata of a subset of a search index held by an index holding unit 102. A user grasps a subset of a search index available in a search by viewing the displayed metadata.

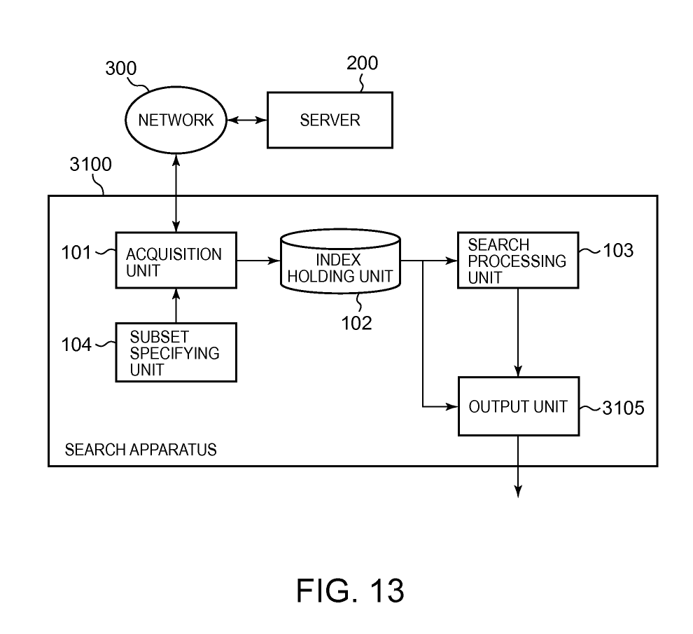

FIG. 13 is a diagram showing a communication system according to the third embodiment.

The search apparatus 3100 according to the third embodiment is different from the search apparatus 100 according to the first embodiment in that the search apparatus 3100 further includes an output unit 3105 and the output unit 3105 displays metadata of a subset of a search index.

Further, an acquisition unit 101 of this embodiment acquires a subset of the search index that is specified by a subset specifying unit 104 from a server 200 and also acquires subset metadata corresponding to the subset of the search index from the server 200, to store them in the index holding unit 102. For example, the subset metadata is human-readable name information of a subset. For example, in the case where the subset is a set related to “Law”, metadata is “Law”.

The user views a presentation using the subset metadata displayed on the output unit 3105 (for example, “search in terms of Law”), thus noticing what type of search is performed.

### Fourth Embodiment

A search apparatus 4100 according to a fourth embodiment performs processing of correcting an orthographic variation of a search keyword input by a user in the search apparatus 4100.

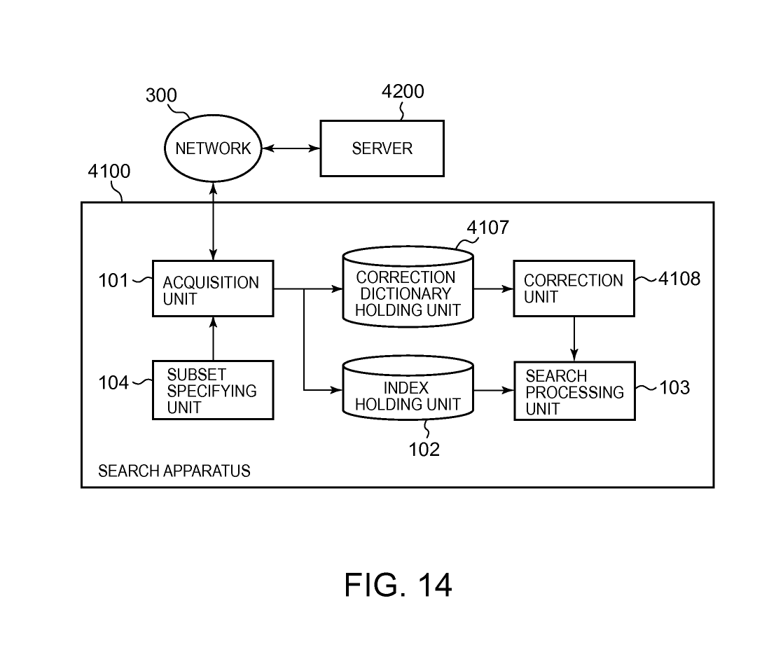

FIG. 14 is a block diagram showing the structure of the search apparatus 4100 according to the fourth embodiment.

The search apparatus 4100 according to the fourth embodiment is different from the search apparatus 100 according to the first embodiment in that the search apparatus 4100 further includes a correction dictionary holding unit 4107 and a correction unit 4108.

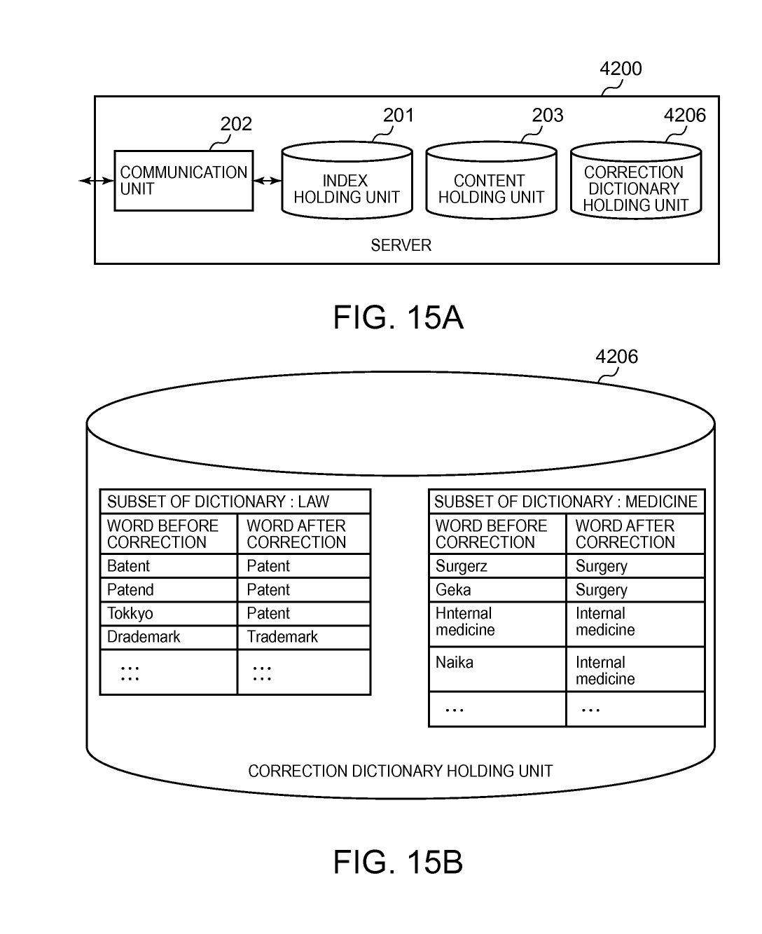

FIG. 15A is a block diagram showing the structure of a server 4200 according to the fourth embodiment. The server 4200 according to the fourth embodiment is different from the server 200 of the first embodiment in that the server 4200 includes a correction dictionary holding unit 4206.

FIG. 15B is a diagram showing an example of information stored by the correction dictionary holding unit 4206. The correction dictionary holding unit 4206 holds correction rules and subsets of a correction dictionary. FIG. 15B shows an example in which the correction dictionary holding unit 4206 holds, as the subsets of the correction dictionary, subsets corresponding to subsets of a search index. A subset of the correction dictionary related to “Law” and a subset of the correction dictionary related to “Medicine” are shown in the example of FIG. 15B. The correction dictionary is constituted of, for example, words before correction (for example, Tokkyo (that means patent in Japanese), Batent, and Patend) and words after correction (for example, Patent). Note that the correction rules are constituted of an application condition (for example, word to be corrected is an English word) and a correction method (for example, conversion of capital letter into small letter, conversion of hiragana (Japanese) into Roman letter).

An acquisition unit 101 of the search apparatus 4100 acquires correction rules and a subset of the correction dictionary from the server 4200.

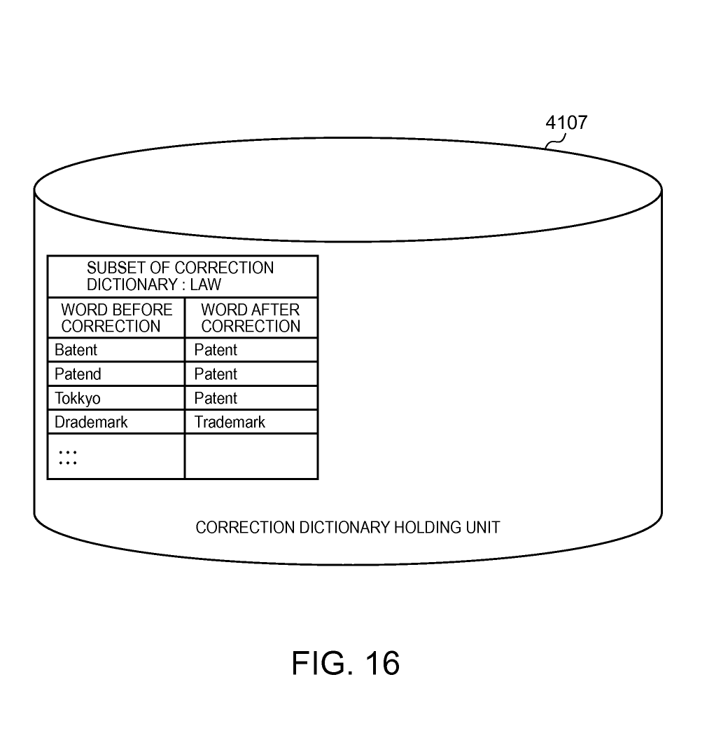

A correction dictionary holding unit 4107 of the search apparatus 4100 holds a subset of the correction dictionary acquired from the server 4200 or the correction rules. FIG. 16 shows an example of a subset of the correction dictionary held by the correction dictionary holding unit 4107. In the example of FIG. 16, a correction dictionary related to “Law” is stored as an example of the subset of the correction dictionary.

The correction unit 4108 corrects a search keyword by using correction rules and a correction dictionary that are held by the correction dictionary holding unit 4107. The correction unit 4108 corrects a search keyword acquired from the input of a user or the like. For example, in the case where a search keyword is input as “Batent”, the correction unit 4108 corrects “Batent” to be “Patent”.

Further, a search processing unit 103 of this embodiment uses the search keyword after correction, which is corrected by the correction unit 4108, and a subset of a search index held by an index holding unit 102, to thereby perform a search. For example, in the case where the index holding unit 102 stores the subset of the search index shown in FIG. 3, a word “Patent” is present as a key. Therefore, search processing is performed using the search keyword after correction, “Patent”.

Since the correction unit 4108 corrects “Batent” to be “Patent”, the search processing unit 103 is allowed to perform the search processing by using data of the index holding unit 102.

As described above, according to the search apparatus 4100 of this embodiment, the correction unit 4108 corrects a search keyword, with the result that a possibility of returning a search result to the user is increased and the convenience of the user is enhanced.

Further, for the correction dictionary, a subset of dictionary data that corresponds to a subset of the search index is acquired. Therefore, even when a data amount of a total set of dictionary data held by the server 4200 exceeds a data amount capable of being held by the search apparatus 4100, the acquisition of a subset allows appropriate processing of correcting an orthographic variation to be performed.

### Fifth Embodiment

A search apparatus 5100 according to a fifth embodiment is an apparatus that accesses, in the case where a search result of search processing by the search apparatus 5100 is unsatisfactory, a server 200 and performs search processing so that the server 200 complements the search processing by the search apparatus 5100.

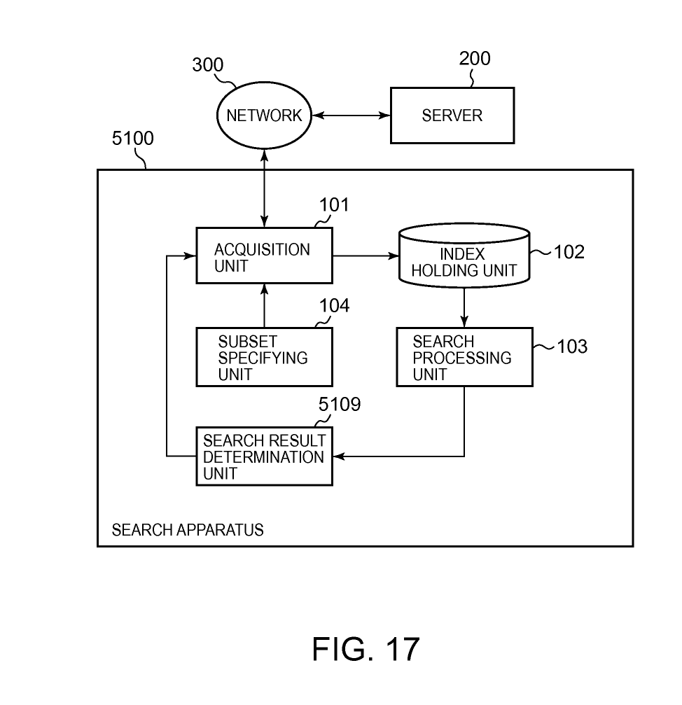

FIG. 17 is a block diagram showing the structure of the search apparatus 5100 according to the fifth embodiment.

The search apparatus 5100 according to the fifth embodiment is different from the search apparatus 100 according to the first embodiment in that the search apparatus 5100 includes a search result determination unit 5109.

The search result determination unit 5109 determines whether a search result of a search processing unit 103 is a satisfactory result or an unsatisfactory result. The search result determination unit 5109 determines that a search result is unsatisfactory in the case where, for example, no content IDs as search results obtained in search processing by the search processing unit 103 are found, or determines that a search result is satisfactory in other cases. Note that zero search results do not need to be a reference of the number of search results, which determines whether a search result is satisfactory or unsatisfactory. For example, it is determined based on whether the number of search results is larger or lower than a predetermined threshold value. Note that some cases where a search result is unsatisfactory are assumed. A first case is that data of all subsets of a search index is not acquired by an acquisition unit 101 due to a data amount capable of being held by the search apparatus 5100 or the like. For example, this is the case where out of the subsets of the search index, data having an initial character of a character string in the range of “A” to “F” is acquired, but data having an initial character of a character string in the range of “G” to “Z” is not acquired. In this case, for example, when a word containing any of “G” to “Z” is input as a search keyword, even if the search keyword is a word included in a character string of a subset of the search index, no search results are found. A second case is that a search keyword input by a user is not included in a character string of a subset of the search index held by an index holding unit 102. For example, this is the case where the subset is a subset related to “Law”, and the input search keyword is a word related to “Food”.

In the case where the search result determination unit 5109 determines that the search result is unsatisfactory, the acquisition unit 101 accesses the server 200 to perform search processing in the server 200. In the case where the search processing is performed in the server 200, the acquisition unit 101 acquires a search result of the search processing by the server 200.

According to the search apparatus 5100 of this embodiment, in the case where the search result determination unit 5109 determines that the search result is unsatisfactory, the server 200 complements the search processing. As a result, more appropriate search processing is performed.

An effect of at least one of the embodiments described above resides in that even in the case where the user terminal acquires a partial search index in the entire search index held by the server, the user terminal obtains an appropriate search result by using the partial search index.

Note that the example in which the server and the search apparatus are connected to each other via the network has been described in the first to fifth embodiments. However, the server and the search apparatus are not necessarily connected to each other via the network. The server and the search apparatus only need to be communicable with each other.

These embodiments have been presented by way of example only, and are not intended to limit the scope of the inventions. Indeed, the novel methods and systems described herein may be embodied in a variety of the other forms; furthermore, various omissions, substitutions and changes in the form the methods and systems described herein may be made without departing from the spirit of the inventions. The accompanying claims and their equivalents are intended to cover such forms or modifications as would fall within the scope and spirit of the inventions.

The process program(s) according to this embodiment may be provided after being recorded on a computer readable recording medium, such as a CD-ROM (Compact Disk Read Only Memory), flexible disk (FD), CD-R (Compact Disk Recordable), DVD (Digital Versatile Disk), in the form of an installable format file or executable format file.

The process program(s) according to this embodiment may be stored on a computer connected to a network, such as the Internet, and may be downloaded through the network so as to be provided. The process program(s) according to this embodiment may be provided or delivered through a network, such as the Internet.

The process program(s) of this embodiment may be incorporated in the ROM or the like so as to be provided.

What is claimed is:

1. A search apparatus configured to be communicable with a server capable of separating a total set of a search index into a plurality of subsets and providing the plurality of subsets, the search apparatus comprising:
a specifying unit configured to specify a specific subset from the plurality of subsets;
an acquisition unit configured to acquire the subset specified by the specifying unit from the server;
a holding unit configured to hold the subset acquired by the acquisition unit; and
a searching unit configured to perform a search by using a search index of the subset held by the holding unit.

2. The search apparatus according to claim 1, wherein
the specifying unit specifies the specific subset based on apparatus information that is information on a state of the search apparatus.

3. The search apparatus according to claim 2, wherein
the apparatus information includes information on one of a free space of a storage area of the holding unit and a processing ability of the search apparatus.

4. The search apparatus according to claim 1, wherein
the specifying unit specifies the specific subset based on user information on a user of the search apparatus.

5. The search apparatus according to claim 4, wherein
the user information includes one of an action history and a preference history of the user.

6. The search apparatus according to claim 1, wherein
the search index includes metadata,
the acquisition unit is configured to acquire the metadata of the search index from the server, and
the specifying unit is configured to specify the specific subset based on the metadata acquired by the acquisition unit.

7. The search apparatus according to claim 1, wherein
the server is capable of providing subset metadata that is metadata of each of the plurality of subsets,
the acquisition unit is configured to acquire the subset metadata from the server, and
the specifying unit is configured to specify the specific subset based on the subset metadata.

8. The search apparatus according to claim 1, wherein
the server is capable of providing subset metadata that is metadata of each of the plurality of subsets,
the acquisition unit is configured to acquire the subset metadata from the server, and
the holding unit is configured to hold the subset metadata acquired by the acquisition unit,
the search apparatus further comprising an output unit configured to present the subset metadata held by the holding unit to a user.

9. The search apparatus according to claim 1, wherein
the acquisition unit is configured to acquire a set of content from the server before the search using the search index constituting the specific subset held by the holding unit.

10. The search apparatus according to claim 1, wherein
the acquisition unit configured to acquire one of a rule and a dictionary for correcting an orthographic variation on a character string constituting the search index constituting the specific subset held by the holding unit,
the search apparatus further comprising:
a dictionary holding unit configured to hold one of the rule and the dictionary; and
a correction unit configured to correct an orthographic variation on a search keyword input by a user by using one of the rule and the dictionary held by the dictionary holding unit, to thereby correct the search keyword to be the character string.

11. The search apparatus according to claim 1, further comprising,
a search result determination unit configured to determine whether a search result of the search processing unit is satisfactory or unsatisfactory,
wherein the acquisition unit configured to acquire a search result processed by the server in a case where the search result determination unit determines that the search result is unsatisfactory.

12. A computer readable medium storing a program that controls a terminal communicable with a server capable of separating a total set of a search index into a plurality of subsets and providing the plurality of subsets, the program causing the terminal to execute:
specifying a specific subset from the plurality of subsets;
acquiring the subset specified by the specifying from the server;
holding the subset acquired by the acquiring; and
performing a search by using a search index of the subset held by the holding.

13. A computer readable medium storing the program causing the terminal to execute according to claim 12, wherein
the function of specifying specifies the specific subset based on apparatus information that is information on a state of the search apparatus.

14. A computer readable medium storing the program causing the terminal to execute according to claim 13, wherein
the apparatus information includes information on one of a free space of a storage area of the holding function and a processing ability of the search apparatus.

15. A computer readable medium storing the program causing the terminal to execute according to claim 14, wherein
the function of specifying specifies the specific subset based on user information on a user of the search apparatus.

16. A computer readable medium storing the program causing the terminal to execute according to claim 15, wherein
the user information includes one of an action history and a preference history of the user.

17. A computer readable medium storing the program causing the terminal to execute according to claim 12, wherein
the search index includes metadata,
the function of acquisition is configured to acquire the metadata of the search index from the server, and
the function of specifying is configured to specify the specific subset based on the metadata acquired by the acquisition unit.

18. A computer readable medium storing the program causing the terminal to execute according to claim 12, wherein
the function of acquisition is configured to acquire a set of content from the server before the search using the search index constituting the specific subset held by the holding function.

19. A computer readable medium storing the program causing the terminal to execute according to claim 12, wherein
the function of acquisition is configured to acquire one of a rule and a dictionary for correcting an orthographic variation on a character string constituting the search index constituting the specific subset held by the holding function,
the program further causing the terminal to execute:
holding one of the rule and the dictionary; and
correcting an orthographic variation on a search keyword input by a user by using one of the rule and the dictionary, to correct the search keyword to be the character string.

20. A computer readable medium storing the program further causing the terminal to execute according to claim 12,
determining whether a search result of the search function is satisfactory or unsatisfactory,
wherein the function of acquisition is configured to acquire a search result processed by the server in a case where the search result determination function determines that the search result is unsatisfactory.
